(19) United States
(12) Patent Application Publication
(10) Pub. No.: US 2006/0068273 A1
(43) Pub. Date: Mar. 30, 2006

(54) Cap assembly having a vent plate and rechargeable battery with same

(75) Inventor: Seok-Yoon Yoo, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/232,872

(22) Filed: Sep. 23, 2005

(30) Foreign Application Priority Data
Sep. 24, 2004 (KR) 10-2004-0077054

(51) Int. Cl. H01M 2/12; H01M 2/02; H01M 10/50

(52) U.S. Cl. 429/82; 429/164; 429/62

(57) ABSTRACT

The rechargeable battery comprises an electrode assembly including a positive electrode, a negative electrode, and a separator interposed between the two electrodes. The battery further comprises a container that houses the electrode assembly and a cap assembly that is coupled with the container, wherein the cap assembly includes a vent plate at least a portion of which has a multiple layer structure.

### CROSS REFERENCE TO RELATED APPLICATION

This application claims priority to and the benefit of Korean Patent Application No. 10-2004-0077054, filed in the Korean Intellectual Property Office on Sep. 24, 2004, the entire disclosure of which is incorporated herein by reference.

### BACKGROUND OF THE INVENTION

1. Field of the Invention

The present invention relates to a rechargeable battery, a structure of a vent plate for the rechargeable battery, and a cap assembly for the rechargeable battery.

2. Description of the Background

Unlike nonrechargeble batteries, rechargeable batteries may be recharged repeatedly. A low power rechargeable battery in which a battery cell is made into a battery pack is used as the power source for various portable electronic devices such as cellular phones, laptop computers, and camcorders. A high power rechargeable battery in which multiple battery cells are made into a battery pack is used as the power source for motor-driven devices such as hybrid electric vehicles.

Rechargeable batteries may be classified into different types, depending on their external shape, such as square and cylindrical batteries. A rechargeable battery includes an electrode assembly in which a belt-shaped positive electrode and negative electrode are wound together with a separator interposed therebetween. The electrode assembly is placed inside a container, and a cap assembly with an external terminal is mounted on the container.

Conductive leads are coupled with the positive electrode and the negative electrode, respectively, to collect electric current that is generated when the battery operates. The lead terminals are coupled with the positive electrode and the negative electrode by welding to induce the current that is generated from the positive electrode and the negative electrode to the positive terminal and the negative terminal, respectively.

However, when the above structure is applied to the high power battery, it may not satisfy the dynamic kinetics necessary for the larger batteries. Accordingly, rechargeable batteries that include a multi-tab structure in which multiple leads are attached to the electrode assembly have been provided. In addition, U.S. Pat. No. 6,193,765 disclosed that a plate is used for a lead element rather than a tab-shaped lead.

In addition, a cap assembly is mounted in an opening of the container of the battery to seal the container. The cap assembly includes a safety vent that discharges gas from is the inside of the container to the outside of the container in the event of a pressure build-up to maintain safe operation of the battery. The safety vent is generally mounted in a vent plate that is coupled with the container by molding them together with other elements when the cap assembly is assembled.

However, since the vent plate is a thin plate, it can easily be deformed by the 20 force that is applied when the cap assembly is fixed to the container by clamping. In addition, the strength of the seal between the cap assembly and the container of the conventional battery is decreased by the deformation of the vent plate that may occur during the battery manufacturing process.

### SUMMARY OF THE INVENTION

The present invention provides a rechargeable battery that can prevent deformation of the vent plate during the manufacturing process.

Additional features of the invention will be set forth in the description which follows, and in part will be apparent from the description, or may be learned by practice of the invention.

The present invention discloses a rechargeable battery comprising an electrode assembly comprising a positive electrode, a negative electrode, and a separator interposed between the two electrodes. The battery further comprises a container for housing the electrode assembly and a cap assembly that is coupled with the container to seal the container. The cap assembly includes a vent plate wherein at least a portion of the vent plate has a multiple layered structure.

The present invention also discloses a cap assembly for a rechargeable battery comprising a cap plate that has a terminal and a vent plate that has a bent portion formed by folding the front end thereof.

The present invention also discloses a vent plate for a rechargeable battery comprising a plate type body, a vent formed on the body to be opened at a prescribed pressure level, and a reinforcement portion formed along the front end of the body.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view of a rechargeable battery according to a first exemplary embodiment of the present invention.

FIG. 2 is a perspective view of a vent plate of the rechargeable battery according to the first exemplary embodiment of the present invention.

FIG. 3 is a cross-sectional view taken along I-I line of FIG. 2.

FIG. 4 is a cross-sectional view of a vent plate of a rechargeable battery according to a second exemplary embodiment of the present invention.

FIG. 5 is a schematic block diagram showing a rechargeable battery module having a rechargeable battery driving a motor according to the present invention.

### DETAILED DESCRIPTION OF THE ILLUSTRATED EMBODIMENTS

The rechargeable battery of the present invention may minimize deformation of the vent plate that may occur during the manufacturing process. In particular, the front end of the vent plate is bent so that some portions of the vent plate form a multiple layer structure, which may increase the strength of the vent plate of a thin plate structure. Thus, the vent plate may closely contact a gasket to improve the seal and enhance the performance of the rechargeable battery.

The rechargeable battery of the present invention may be used to power motor driving devices that require high power such as the hybrid electric vehicles, electric vehicles, wireless vacuum cleaners, motorbikes, or motor scooters.

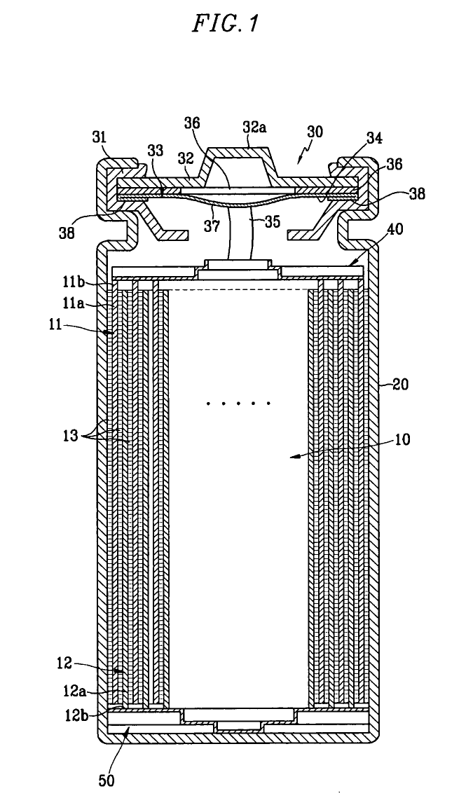

FIG. 1 is a cross-sectional view of a rechargeable battery according to a first exemplary embodiment of the present invention.

As shown in FIG. 1, a rechargeable battery of the present embodiment comprises an electrode assembly 10 comprising a positive electrode 11, a negative electrode 12, and a separator 13 interposed between the two electrodes. The battery further comprises a container 20 that has an opening at one end thereof and houses the electrode assembly 10 with an electrolyte, and a cap assembly 30 mounted on the opening of the container 20 through a gasket 31 to seal the container 20.

The container 20 comprises a conductive metal such as aluminum, an aluminum alloy, and steel plated with nickel. The container may have a cylindrical shape that has an inner space to receive the electrode assembly 10, but its shape is not limited thereto and can have other shapes such as a rectangular box, for example.

The electrode assembly 10 has a stacked layer structure such that the separator 13 is interposed between the positive electrode 11 and the negative electrode 12 which have collectors 11a and 12a coated with active material, respectively. Alternatively, the electrode assembly 10 may have a jellyroll structure where the positive electrode 11, the negative electrode 12, and the separator 13 are stacked and are wound into a jellyroll configuration.

The present embodiment of FIG. 1 shows an example of a rechargeable battery that has a cylindrical shaped container 20 in which a jellyroll electrode assembly 10 is mounted.

The positive collector plate 40 and the negative collector plate 50 of the electrode assembly 10 are coupled with the positive electrode 11 and the negative electrode 12, respectively, to form an electrode package. As shown in FIG. 1, if the container 20 stands vertically so that the cap assembly 30 is disposed on the upper portion of the electrode package, an uncoated region 12b that is not coated with the negative active material is formed in the lower end of the negative electrode 12 along the edge of the collector 12a of the negative electrode 12 and is coupled with the negative collector plate 50. In the upper end of the positive electrode 11, an uncoated region 11b that is not coated with the positive active material is formed along the edge of the collector 11a of the positive plate 11 and is coupled with the positive collector plate 40.

The cap assembly 30 includes a cap plate 32 that has a terminal 32a and a gasket 31 that is disposed between the cap plate 32 and the container 20 to insulate them. The cap assembly 30 further comprises a vent plate 33 that has a safety vent 37 that breaks at a prescribed pressure to discharge the gas that is generated inside the container 20 to the outside of the container 20, to prevent the explosion of the battery.

A lead element 35 is coupled with both the vent plate 33 and the positive collector plate 40 so that cap assembly 30 is coupled with the positive electrode 11 of the electrode assembly 10.

In addition, a positive temperature coefficient (PTC) device 36 may be provided between the cap plate 32 and the vent plate 33.

In the present embodiment, the cap assembly 30 has a structure such that the cap plate 32, the PTC device 36, and the vent plate 33 are sequentially stacked, and the gasket 31 is disposed along their circumference area to entirely surround them.

The gasket 31 comprises a material that has insulation and elastic properties, and seals the container 20 while insulating the cap assembly 30 which forms the positive electrode, from the container 20, which forms the negative electrode of the rechargeable battery.

The cap assembly 30 is mounted on the opening of the container 20. Then, the cap assembly 30 is coupled with the container 20 by clamping and molding the container 20 with the circumference area of the cap assembly 30.

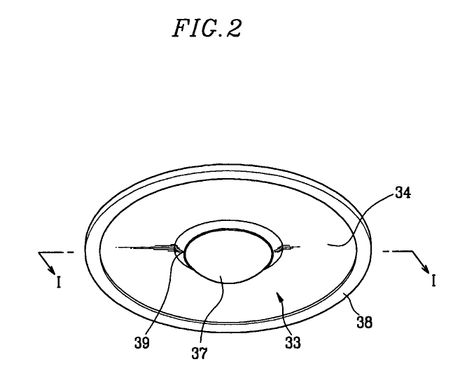

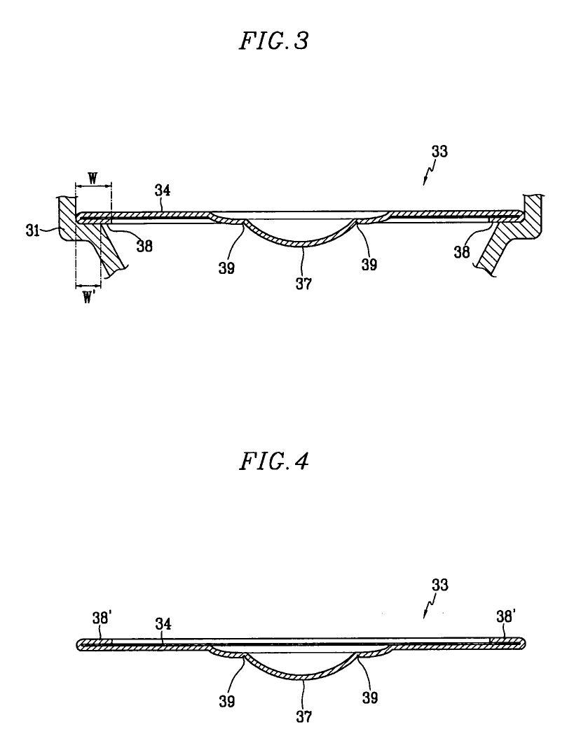

FIG. 2 is a perspective view of a vent plate of the rechargeable battery according to the first embodiment of the present invention, and FIG. 3 is a cross-sectional view taken along I-I line of FIG. 2.

As shown in FIG. 2, the vent plate 33 has a disk shaped body 34. The safety vent 37 is disposed in the center of the body 34 to project toward the inside of the container 20, that is, toward the electrode assembly 10. A notch 39 is formed along the circumference of the safety vent 37.

The front end of the vent plate 33 is bent about 180 degrees toward the inside to form a bent portion 38. The bent portion 38 reinforces the strength of the vent plate 33 and is formed as an integral part, continuously along the circumference of the vent plate 33 with a predetermined width, w.

The bent portion 38 is substantially closely coupled with the gasket 31 when the gasket 31 is compressed against the container 20 to seal it. The width, w, of the bent portion is may be equal to or greater than the width, w′, of the contact area of the gasket 31 with the bent portion when the gasket 31 is deformed by clamping with the container 20.

Such a bent portion 38 may reinforce the strength of the vent plate 33, which may minimize deformation even if force is applied by clamping with the container 20, and additionally, may increase close contact with the gasket 31 to achieve the efficient sealing.

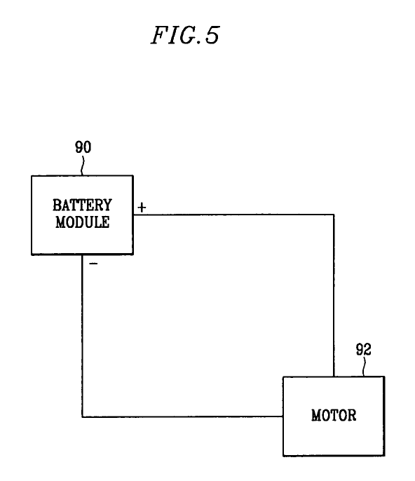

The bent portion 38 may be bent in a direction facing the electrode assembly 10 together with the projected direction of the safety vent 37, as shown in FIG. 1 and FIG. 3. Alternatively, as shown in FIG. 4, the bent portion 38′ may be bent in a direction opposite the safety vent 37. In such a case, the bent portion 38′ is substantially arranged in the direction opposite to the electrode assembly 10.

FIG. 5 is a schematic block diagram of a rechargeable battery module 90 having a rechargeable battery as discussed in FIGS. 1 to 4 driving a motor 92.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A battery, comprising:
an electrode assembly comprising a positive electrode, a negative electrode, and a separator interposed between the electrodes;
a container that houses the electrode assembly; and
a cap assembly coupled with the container,
wherein the cap assembly comprises a vent plate,
wherein at least a portion of the vent plate has a multiple layer structure.

2. The battery of claim 1,
wherein the vent plate has a bent portion that is formed by folding a front end of the vent plate inward.

3. The battery of claim 2,
wherein the cap assembly is coupled with the container through a gasket, and
wherein the bent portion is coupled with the gasket.

4. The battery of claim 3,
wherein a width of the bent portion is equal to or greater than a width of a contact area between the bent portion and the gasket.

5. The battery of claim 2,
wherein the bent portion is arranged to face the electrode assembly.

6. The battery of claim 2,
wherein the bent portion is arranged opposite the electrode assembly.

7. The battery of claim 1,
wherein the battery has a substantially cylindrical shape.

8. The battery of claim 1,
wherein the battery is for a motor-driven device.

9. A cap assembly for a battery, comprising:
a cap plate; and
a vent plate that comprises a bent portion that is formed by folding a front end of the vent plate.

10. The cap assembly of claim 9, further comprising a positive temperature coefficient device arranged between the cap plate and the vent plate.

11. A vent plate for a battery, comprising:
a plate type body;
a vent formed on the body to be opened at a prescribed pressure level; and
a reinforcement portion formed along a front end of the body.

12. The vent plate of claim 11,
wherein the reinforcement portion includes a bent portion that is formed by folding the front end of the body toward the body.

13. The vent plate of claim 12, wherein the bent portion is arranged to face the vent.

14. The vent plate of claim 12,
wherein the bent portion is arranged opposite the vent.
